(19) United States
(12) Patent Application Publication
(10) Pub. No.: US 2020/0257630 A1
(43) Pub. Date: Aug. 13, 2020

(54) INFORMATION PROCESSING APPARATUS, INFORMATION PROCESSING METHOD, AND COMPUTER READABLE MEDIUM

(71) Applicant: Mitsubishi Electric Corporation, Tokyo (JP)

(72) Inventors: Tatsuya YAMADA, Tokyo (JP); Hirotaka MOTAI, Tokyo (JP); Akio IDEHARA, Tokyo (JP); Kotaro HASHIMOTO, Tokyo (JP); Takehisa MIZUGUCHI, Tokyo (JP)

(73) Assignee: Mitsubishi Electric Corporation, Tokyo (JP)

(21) Appl. No.: 16/652,945

(22) PCT Filed: Dec. 18, 2017
(86) PCT No.: PCT/JP2017/045336

§ 371 Date: Apr. 1, 2020

(51) Int. Cl. G06F 12/0871; G06F 12/122; G06F 11/30; G06F 21/78; G06F 9/4401

(52) U.S. Cl. CPC G06F 12/0871; G06F 12/122; G06F 9/4411; G06F 21/78; G06F 11/3037

(57) ABSTRACT

A history storage area (106) stores, for each of a plurality of pieces of data, number of times of access via a file system. A cache management unit (119), when access to the plurality of pieces of data not via the file system occurs, sets as overwrite prohibition data and caches in a disc cache area (108), data for which number of times of access that is equal to or more than a threshold is stored in the history storage area (106), the threshold being determined based on number of times of access of the plurality of pieces of data.

### TECHNICAL FIELD

The present invention relates to an information processing apparatus, an information processing method, and an information processing program.

### BACKGROUND ART

A general operating system (OS) caches data read out from a storage in memory (mainly, dynamic random access memory (DRAM)). This eliminates necessity of access to the storage when the same data is read out next time, and thus accelerates data access. And, data cached in a cache area (hereinafter referred to also as, a disc cache) is discarded by an algorithm, such as LeastRecentlyUsed. By discarding the data by such algorithm, the cache area can be used efficiently.

A conventional OS selects a disc block from which data is read out by setting priorities on pages based on information on efficiency of input/output (I/O) prefetch and memory usage, and thus accelerates file access (for example, Patent Literature 1).

Also, a method is proposed that prevents overlapping access from occurring at time of a memory readout by recording status of memory that is in an operational state in a storage and returning to the memory, the status of memory recorded in the storage, when an information processing apparatus is activated next time (for example, Patent Literature 2).

And further, a basic method of caching is proposed that arranges a high-speed storage medium between a slow storage and a central processing unit (CPU) and temporarily stores data read out from the slow storage in the high-speed storage medium (for example, Patent Literature 3).

### CITATION LIST

### Patent Literature

Patent Literature 1: JP 4724362

Patent Literature 2: JP 6046978

Patent Literature 3: JP S58-224491 A

### SUMMARY OF INVENTION

### Technical Problem

A conventional technology is based on an assumption that a subject that uses data and a subject that caches the data are the same. Accordingly, if the subject that uses the data and the subject that caches the data are different, the conventional technology does not make effective use of a history of data readout by the subject different from the subject that caches the data. Therefore, the conventional technology has a problem that data access cannot be accelerated effectively in such case. In specific, a history of data readout via a file system provided by an OS is not utilized in a disc cache generated not via the file system. Therefore, there is a possibility that cache data that is used frequently in data readout via the file system is overwritten when data readout not via the file system is made, thus leading to deterioration in performance.

Also, in many cases, on an embedded platform, an area in which an OS and an application program (hereinafter referred to simply as, an application) are stored is an area dedicated to readout. Therefore, a sequence from supplying of power to an information processing apparatus to activation of an application is often fixed. And also, a position of a data block from which accesses to a storage are made and its access timing are often deterministic.

In carrying out a secure boot on the embedded platform, it is necessary to verify integrity and authenticity of code data that constitutes the application before using a partition in which the application is stored. Therefore, it is necessary to have the verification of integrity and authenticity of the code data that constitutes the application completed before the OS is activated and the application is read out via the file system. In other words, in verification of the partition (verification of the integrity and the authenticity of the code data that constitutes the application), the code data of the application is read out not via the file system, but directly from a device driver. Therefore, there occurs a problem that the code data read out in the verification of the partition is not included in a disc cache of the file system.

The main objective of the present invention is to solve the problem. More specifically, the objective of the present invention is to carry out efficient cache management under a configuration in which data access via a file system and data access not via the file system occur.

### Solution to Problem

An information processing apparatus according to the present invention includes:

a cache area;

an access times storage area to store number of times of access via a file system for each of a plurality of pieces of data; and

a cache management unit, when access to the plurality of pieces of data not via the file system occurs, to set as overwrite prohibition data and to cache in the cache area, data for which number of times of access that is equal to or more than a threshold is stored in the access times storage area, the threshold being determined based on number of times of access of the plurality of pieces of data.

### Advantageous Effects of Invention

The present invention allows efficient cache management under a configuration in which data access via a file system and data access not via the file system occur.

### BRIEF DESCRIPTION OF DRAWINGS

FIG. 1 is a diagram illustrating an example of a hardware configuration of an information processing apparatus according to Embodiment 1.

FIG. 2 is a diagram illustrating an example of a functional configuration of the information processing apparatus according to Embodiment 1.

FIG. 3 is a diagram illustrating an example of a configuration of a history storage area according to Embodiment 1.

FIG. 4 is a diagram illustrating an example of a configuration of a disc cache area according to Embodiment 1.

FIG. 5 is a diagram illustrating an example of a functional configuration of an information processing apparatus according to Embodiment 2.

FIG. 6 is a diagram illustrating an example of a configuration of a history storage area according to Embodiment 2.

FIG. 7 is a diagram illustrating an example of a functional configuration of an information processing apparatus according to Embodiment 3.

FIG. 8 is a flowchart illustrating an example of operation of the information processing apparatus according to Embodiment 1.

FIG. 9 is a flowchart illustrating the example of the operation of the information processing apparatus according to Embodiment 1.

FIG. 10 is a flowchart illustrating the example of the operation of the information processing apparatus according to Embodiment 1.

FIG. 11 is a flowchart illustrating the example of the operation of the information processing apparatus according to Embodiment 1.

FIG. 12 is a flowchart illustrating the example of the operation of the information processing apparatus according to Embodiment 1.

FIG. 13 is a flowchart illustrating the example of the operation of the information processing apparatus according to Embodiment 1.

### DESCRIPTION OF EMBODIMENTS

Hereinafter, embodiments of the present invention will be explained with drawings. In descriptions of embodiments below and the drawings, a part denoted by a same reference sign indicates a same or corresponding part.

### Embodiment 1

***Description of Configuration***

In the present embodiment, an explanation will be given on a configuration to solve problems that arise when a secure boot is applied on an embedded platform. More specifically, an explanation will be given on a configuration that allows efficient cache management by making readout from a storage not via a file system available as a disc cache of the filesystem and applying a deterministic method to a discarding algorithm of the disc cache.

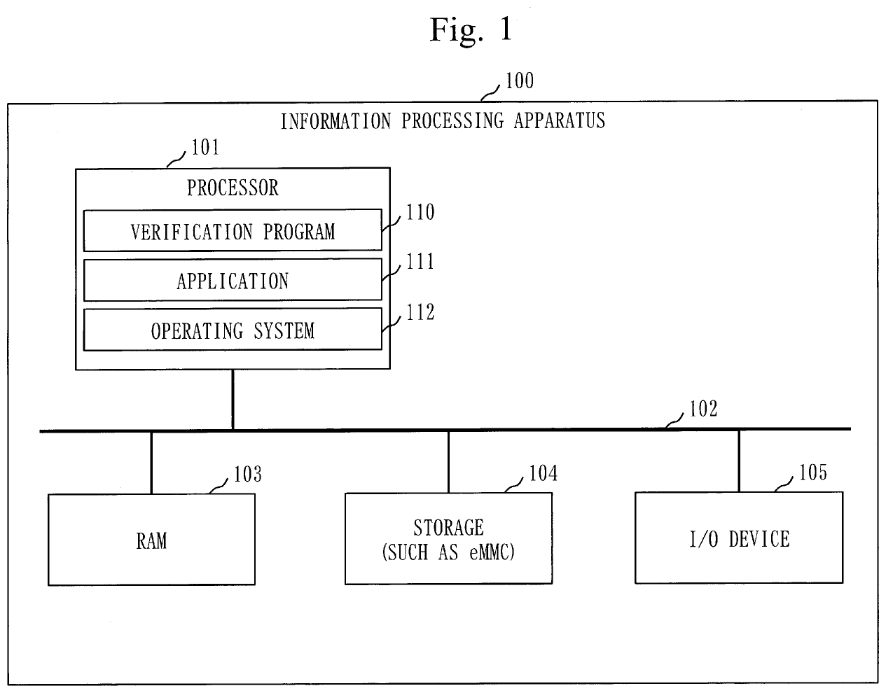

FIG. 1 illustrates an example of a hardware configuration of an information processing apparatus 100 according to the present embodiment.

The information processing apparatus 100 according to the present embodiment is a computer.

As illustrated in FIG. 1, the information processing apparatus 100 includes, as hardware, a processor 101, random access memory (RAM) 103, a storage 104, and an input/output (I/O) device 105. These processor 101, RAM 103, storage 104, and I/O device 105 are connected with each other via a bus 102.

The processor 101 is an arithmetic device that controls the information processing apparatus 100. The processor 101 is, for example, a central processing unit (CPU). The information processing apparatus 100 may include a plurality of processors 101.

The RAM 103 is a volatile storage device in which a program running on the processor 101, a stack, a variable, and the like are stored.

The storage 104 is a nonvolatility storage device in which a program, data, and the like are stored. The storage 104 is, for example, embedded MultiMediaCard (eMMC).

The I/O device 105 is an interface to connect an external device such as a display and a keyboard.

In the present embodiment, it is assumed that the processor 101, the RAM 103, the storage 104, and the I/O device 105 are connected with each other via the bus 102. However, they may be connected with each other by another connecting means.

Note that operation performed on the information processing apparatus 100 is equivalent to an information processing method and an information processing program.

The storage 104 stores programs to realize functions of a verification program 110, an application 111, and an operating system 112, as described later. These programs to realize the functions of the verification program 110, the application 111, and the operating system 112 are loaded into the RAM 102. Then, the processor 101 executes these programs and performs operation of the verification program 110, the application 111, and the operating system 112, as described later.

FIG. 1 schematically illustrates a state in which the processor 101 is executing the programs to realize the functions of the verification program 110, the application 111, and the operating system 112.

Also, at least any of information, data, a signal value and a variable value that indicates a result of process by the verification program 110, the application 111, and the operating system 112 is stored in at least any of the storage 104, the RAM 103, and a register in the processor 101.

Also, the verification program 110, the application 111, and the operating system 112 may be stored in a portable storage medium, such as a magnetic disk, a flexible disk, an optical disc, a compact disc, a Blu-ray (a registered trademark) disc, and a DVD.

Also, the information processing apparatus 100 may be realized by a processing circuit. The processing circuit is, for example, a logic integrated circuit (IC), a gate array (GA), an application-specific integrated circuit (ASIC), or a field-programmable gate array (FPGA).

Note that, in this description, a broader concept of the processor 101 and the processing circuit is called “processing circuitry”.

In other words, each of the processor 101 and the processing circuit is an example of the “processing circuitry”.

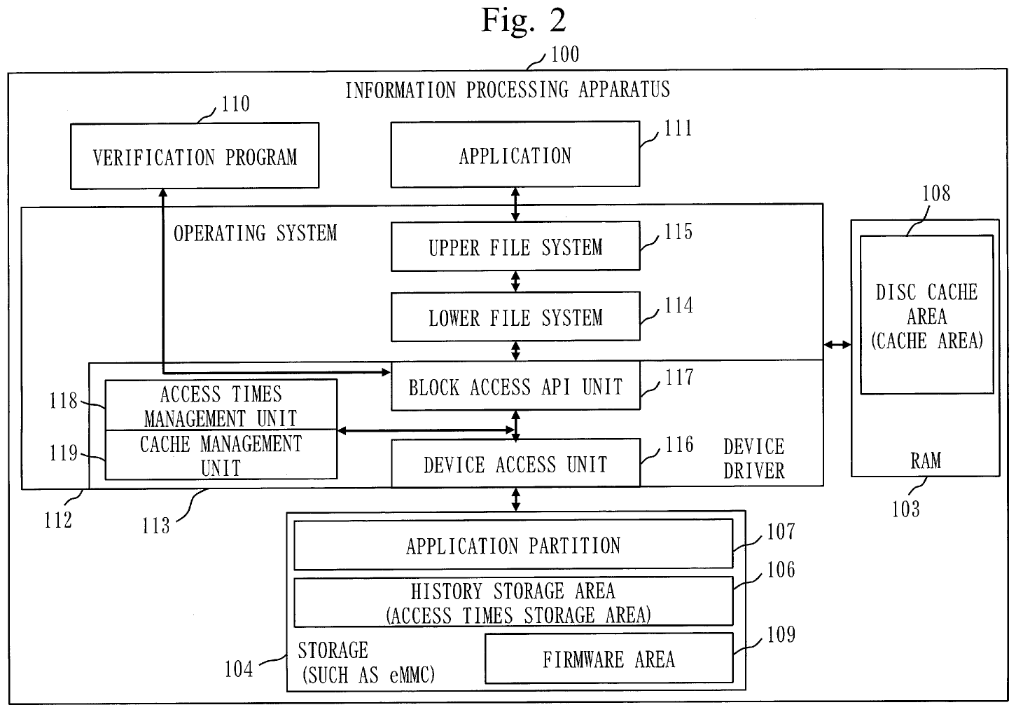

FIG. 2 illustrates an example of a functional configuration of the information processing apparatus 100 according to the present embodiment.

In the information processing apparatus 100, the operating system 112 runs. And, on the operating system 112, the verification program 110 and the application 111 run.

The verification program 110 carries out verification for a secure boot. In other words, the verification program 110 verifies integrity and authenticity of the application 111.

FIG. 2 illustrates a configuration related to a file system out of an internal configuration of the operating system 112.

An upper file system 115 and a lower file system 114 constitute an actual file system that is abstraction of file access available from the application 111.

In some cases, the upper file system 115 and the lower file system 114 are realized as a single file system depending on an operating system. The information processing apparatus 100 according to the present embodiment can be realized without depending on a multiplexing configuration of the file system.

A device driver 113 includes a device access unit 116, a block access application programming interface (API) unit 117, an access times management unit 118, and a cache management unit 119.

The device access unit 116 accesses the storage 104, which is a device.

The block access API 117 is an API that is accessible directly from the lower file system 114 and the verification program 110.

The access times management unit 118 counts number of times of access via the upper file system 115 and the lower file system 114 for each of a plurality of pieces of code data that constitute the application 111. The access times management unit 118 also determines a threshold of number of times of access based on a counted result of the number of times of access for each of the code data.

The number of times of access counted by the access times management unit 118 and the threshold determined by the access times management unit 118 are stored in a history storage area 106 in the storage 104.

When access not via the upper file system 115 nor the lower file system 114 occurs, the cache management unit 119 sets as overwrite prohibition data, and caches in a disc cache area 108, code data for which number of times of access that is equal to or more than a threshold is stored in the history storage area 106. In specific, the access not via the upper file system 115 nor the lower file system 114 occurs when the verification program 110 carries out verification of integrity and authenticity of the plurality of pieces of code data that constitute the application 111. When the verification program 110 carries out the verification, the cache management unit 119 extracts the code data for which the number of times of access that is equal to or more than the threshold is stored in the history storage area 106, and sets as the overwrite prohibition data and caches in the disc cache area 108, the extracted code data.

The cache management unit 119 also writes in the disc cache area 108, the number of times of access of overwrite prohibition data stored in the history storage area 106, associating the number of times of access with the overwrite prohibition data.

The cache management unit 119 further caches in the disc cache area 108, code data for which number of times of access that is less than the threshold is stored in the history storage area 106, without overwriting the overwrite prohibition data.

A process carried out by the cache management unit 119 is equivalent to a cache management process.

The disc cache area 108 used by the operating system 112 is acquired in the RAM 103.

The disc cache area 108 is equivalent to a cache area.

The storage 104 includes an application partition 107, the history storage area 106, and a firmware area 109.

In the application partition 107, an execution image of the application 111 is stored.

In the history storage area 106, the number of times of access for each of the code data counted by the access times management unit 118 and the threshold determined by the access times management unit 118 are stored. The history storage area 106 is equivalent to an access times storage area.

In the firmware area 109, the operating system 112 is stored.

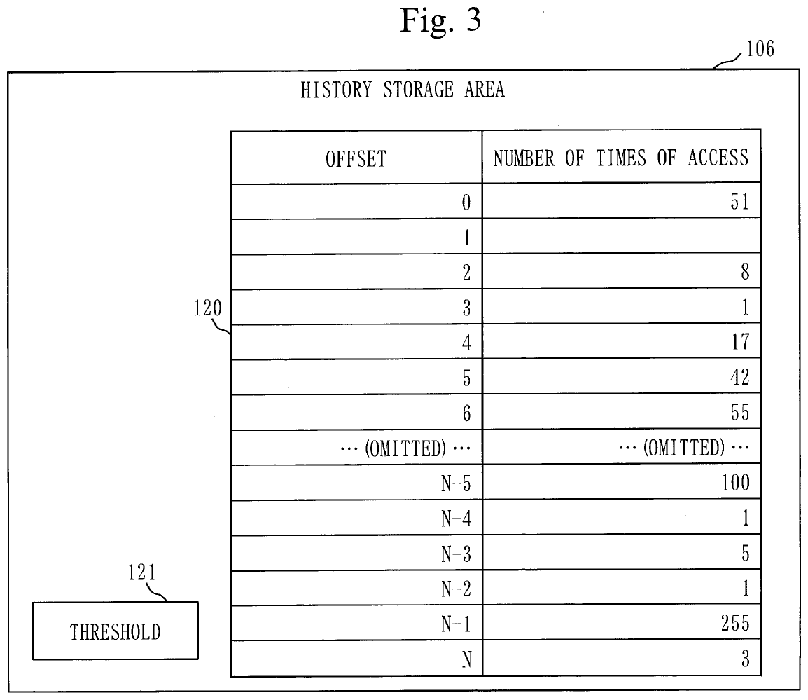

FIG. 3 illustrates an example of a configuration of the history storage area 106 illustrated in FIG. 2.

In the history storage area 106, there is entry 120, number of which is equal to a quotient resulting from dividing size of the application partition 107 by a block size to be used to access the storage 104. Each entry 120 corresponds to code data obtained by dividing the execution image of the application 111 by the block size. In other words, in the example of FIG. 3, the execution image of the application 111 is divided into N pieces of code data.

An offset is provided as a matter of convenience in order to number each entry 120. Therefore, the history storage area 106 stores a value of number of times of access and a threshold 121 only. In the present embodiment, size of one entry of the number of times of access is one byte. However, the size of one entry may be arbitrarily changed depending on capacity of the storage 104.

Size of the threshold 121 is the same as that of one entry of the number of times of access. In other words, in the present embodiment, the size of the threshold 121 is one byte. As described above, the threshold 121 is used by the cache management unit 119 to determine whether or not to set code data as overwrite prohibition data.

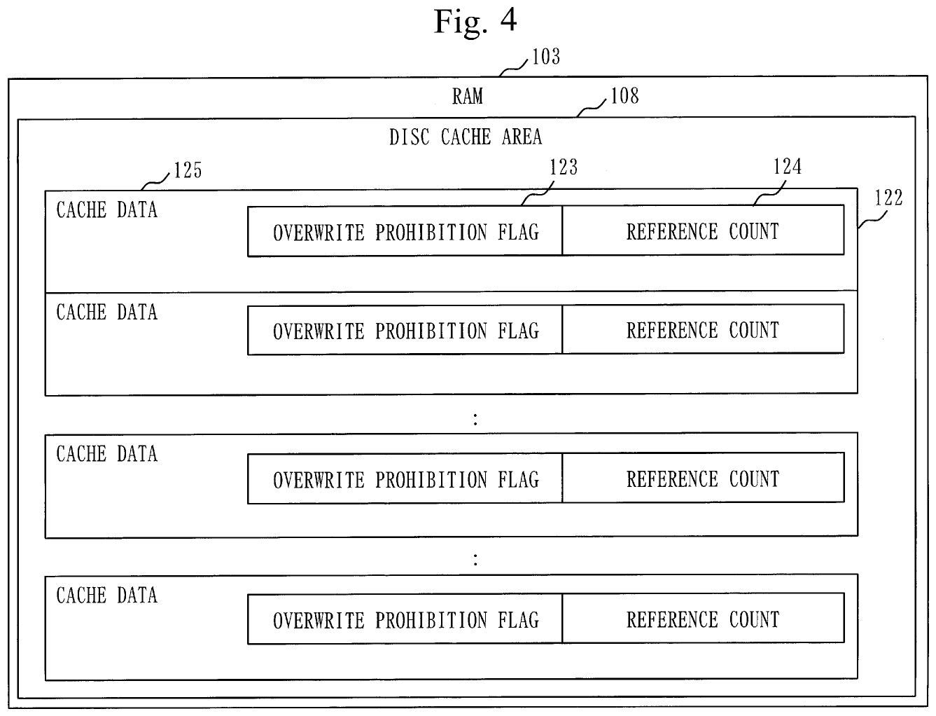

FIG. 4 illustrates an example of a configuration of the disc cache area 108 in the RAM 103 illustrated in FIG. 2.

An entry 122 is an entry of cache data 125. The entry 122 can be continuous, or can be discontinuous.

An arrangement of the entry 122 depends on a way how the device driver 113 acquires a buffer. The information processing apparatus 100 according to the present embodiment can be realized without depending on the way how the device driver 113 acquires the buffer.

The each entry 122 stores the cache data 125, an overwrite prohibition flag 123, and a reference count 124.

The cache data 125 is code data of the application 111 cached by the cache management unit 119.

The cache management unit 119 sets the cache data 125 as overwrite prohibition data by setting the overwrite prohibition flag 123 to ON.

Note that the overwrite prohibition flag 123 consists of at least one bit since it does not matter as long as ON and OFF are distinguishable.

The reference count 124 is the same value as the number of times of access in the history storage area 106. Therefore, size of the reference count 124 needs to be the same as that of the number of times of access.

***Description of Operation***

Next, an explanation will be given on an example of operation of the information processing apparatus 100 according to the present embodiment.

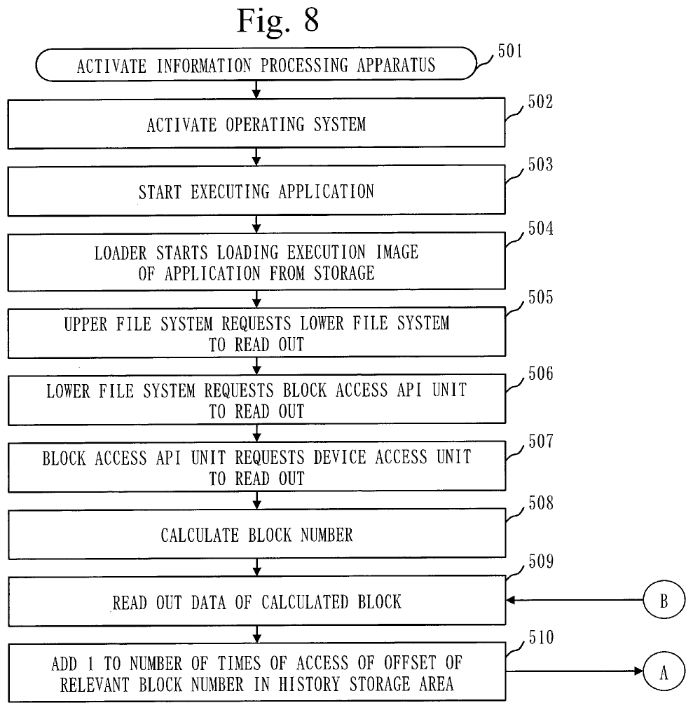

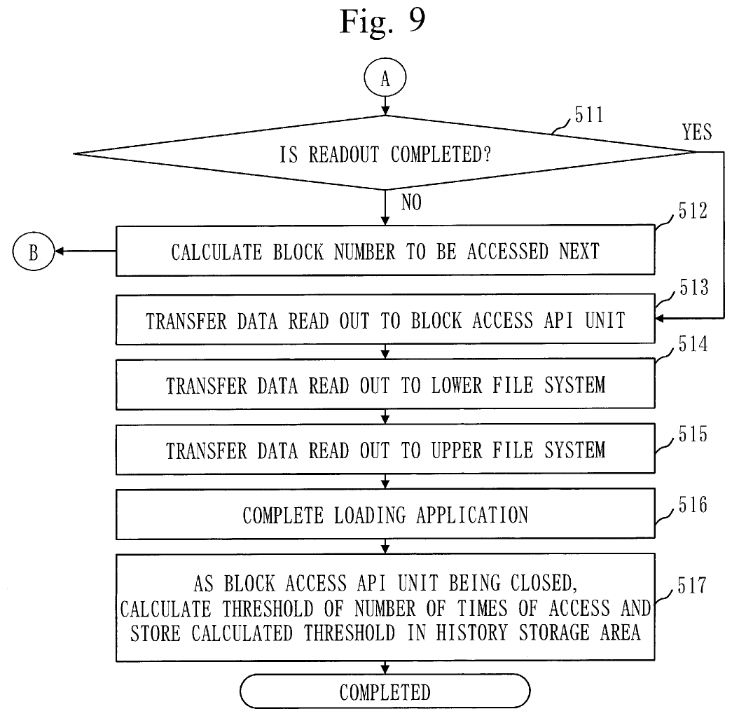

First, referring to FIG. 8 and FIG. 9, a procedure to activate the information processing apparatus 100 in a normal manner and then execute the application 111 in order to learn data on deterministic discarding of cache is implemented.

Upon the information processing apparatus 100 being activated (step 501), the operating system 112 installed is activated (step 502).

Then, after various services by the operating system 112 are executed, execution of the application 111 is started (step 503). At this time, a loader starts readout of an execution image of the application 111 from the storage 104 (step 504).

In reading out the execution image of the application 111, the upper file system 115 requests the lower file system 114 to read out the execution image of the application 111 (step 505). Next, based on the request by the upper file system 115, the lower file system 114 requests the block access API unit 117 to read out the execution image of the application 111 (step 506). Next, based on the request by the lower file system 114, the block access API unit 117 requests the device access unit 116 to read out the execution image of the application 111 (step 507). Next, the device access unit 116 calculates a block number in the storage 104 (step 508).

Next, upon data on the block number calculated in step 508 being read out by the device access unit 116, code data, which is a part of the execution image of the application 111, is acquired (step 509).

At this time, the access times management unit 118 adds one to number of times of access 120 of an offset corresponding to the block number in the history storage area 106 (step 510).

Alternatively, the cache management unit 119 may cache in the disc cache area 108, the code data read out.

Note that if the readout of the application 111 is not completed (NO in step 511), the device access unit 116 calculates a block number to be read out next (step 512).

Then, readout of code data of the calculated block number and addition to number of times of access of an offset corresponding to the block number are repeated (steps 509 and 510).

Upon loading of the application 111 being completed, the block access API unit 117 is closed (steps 512 to 516).

As the block access API unit 117 being closed, the access times management unit 118 calculates a threshold of number of times of access, and writes the calculated threshold as a threshold 121 in the history storage area 106 (step 517).

More specifically, the access times management unit 118 sorts entries 120 in the history storage area 106 in descending order of number of times of access. Then, the access times management unit 118 selects entries 120 of the same number as a half of number of blocks that can be acquired in the disc cache area 108 in descending order of the number of times of access. Then, the access times management unit 118 determines as a threshold, the smallest number of times of access among the numbers of times of access of the selected entries 120.

For example, if a total number of entries in the history storage area 106 is 20 and the number of blocks that can be acquired in the disc cache area 108 is 20, the access times management unit 118 selects 10 entries out of the 20 entries in descending order of the number of times of access. Then, the access times management unit 118 determines as a threshold, the smallest number of times of access out of the numbers of times of access of the 10 selected entries.

Theoretically, it is possible for the access times management unit 118 to select entries of the same number as the number of blocks that can be acquired in the disc cache area 108. However, this selection disables code data newly read out from the storage 104 from being stored in the disc cache area 108. Therefore, the present embodiment selects the entries of the same number as a half of the number of the blocks that can be acquired in the disc cache area 108.

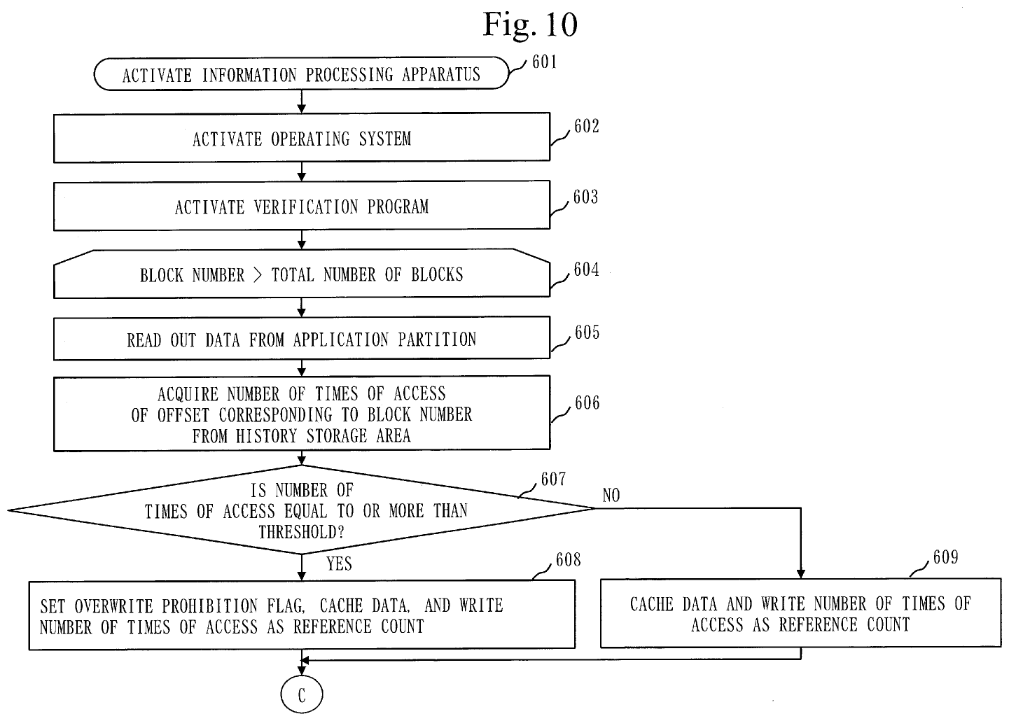

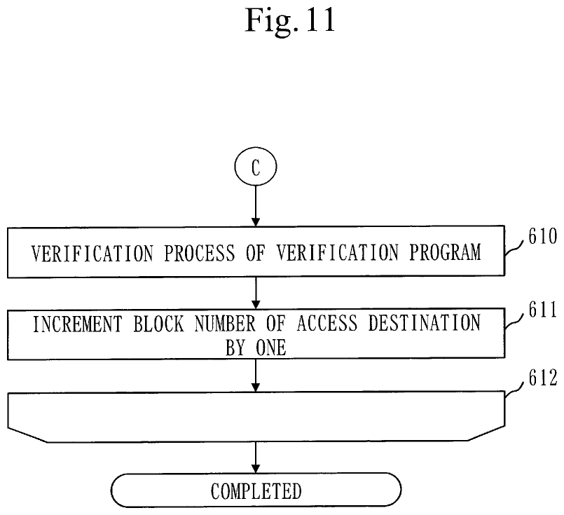

Next, referring to FIG. 10 and FIG. 11, an explanation will be given on operation performed when code data of the application 111 is read out from the application partition 107 in the storage 104 not via the upper file system 115 nor the lower file system 114.

Hereinafter, an explanation will be given on operation performed when the verification program 110 carries out verification of integrity and authenticity of the application 111 like a secure boot and code data of an application is read out by the device driver 113 from the application partition 107 not via the upper file system 115 nor the lower file system 114.

If the information processing apparatus 100 is activated before the application partition 107 in the storage 104 becomes available for use by the upper file system 115 and the lower file system 114 (step 601), the operating system 112 installed is activated (step 602).

Also, the verification program 110 is activated (step 603).

Note that there is no cache data 125 stored in the disc cache area 108 when the information processing apparatus 100 is activated (step 601).

Next, the device access unit 116 reads out code data from a head block of the application partition 107 (step 604). The device access unit 116 transfers the code data read out to the cache management unit 119, and also notifies the cache management unit 119 of a block number of the code data.

The cache management unit 119 acquires from the history storage area 106, number of times of access of an offset corresponding to the block number notified by the device access unit 116 (step 606).

Next, the cache management unit 119 determines whether or not the number of times of access acquired in step 606 is equal to or more than a threshold 121 (step 607).

If the number of times of access acquired in step 606 is equal to or more than the threshold 121 (YES in step 607), the cache management unit 119 sets a overwrite prohibition flag 123 in the disc cache area 108, and writes the code data as cache data 125 in the disc cache area 108 (step 608). As described above, by setting the overwrite prohibition flag 123, the code data is treated as overwrite prohibition data.

The cache management unit 119 also writes a value of the number of times of access in the history storage area 106 as a reference count 124 in the disc cache area 108 (step 608).

On the other hand, if the number of times of access acquired in step 606 is less than the threshold 121 (NO in step 607), the cache management unit 119 writes the code data as the cache data 125 in the disc cache area 108 (step 609). In this case, since the overwrite prohibition flag 123 is not set, the code data is not treated as the overwrite prohibition data.

The cache management unit 119 also writes the value of the number of times of access in the history storage area 106 as the reference count 124 in the disc cache area 108 (step 609).

Next, the verification program 110 verifies integrity and authenticity of the code data read out in step 606 (step 610).

Next, the device access unit 116 increments a block number of an access destination by one (step 611).

After this and until the block number of the access destination exceeds a total number of blocks in the application partition 107, operation from step 605 to step 611 is repeated (step 604, step 612). In other words, the operation from step 605 to step 611 is repeated for the whole application partition 107.

Since the application partition 107 subject to the verification program 110 has a larger capacity than that of the disc cache area 108 in general, old cache data 125 is to be overwritten by code data read out thereafter.

In writing code data in the disc cache area 108, the cache management unit 119 looks for an area in which the overwrite prohibition flag 123 is not ON, that is, an area in which overwriting is possible, and writes the code data in the area in which the overwriting is possible. If there is any code data that has been stored already in the area in which overwriting is possible, such code data is to be overwritten by new code data.

Cache data 125 in an area in which the overwrite prohibition flag 123 is ON (that is, the overwrite prohibition data) is kept in the disc cache area 108 without being overwritten by another code data.

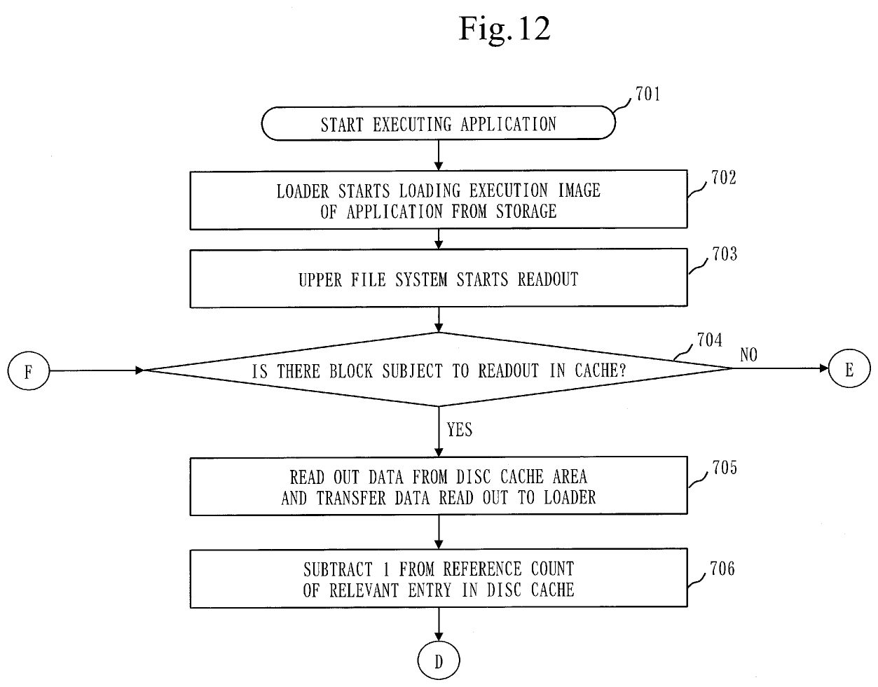

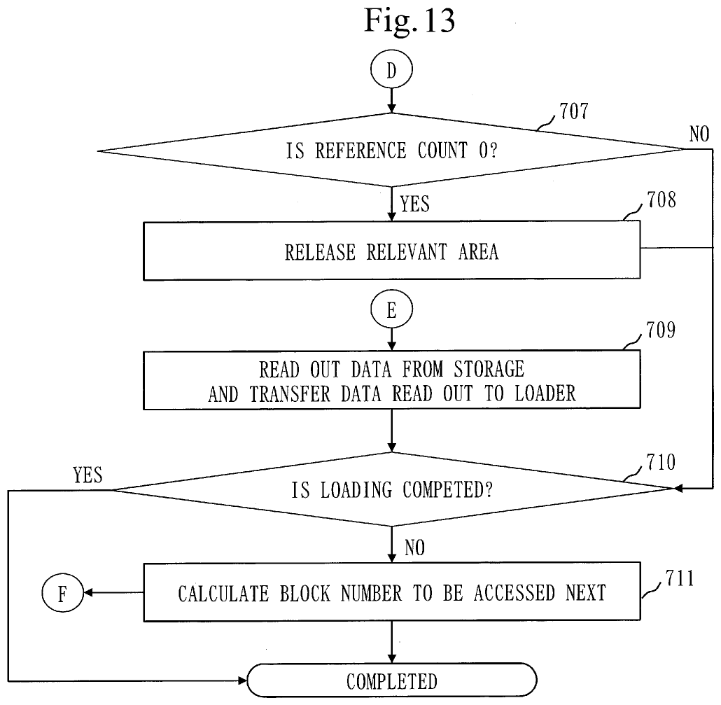

Next, referring to FIG. 12 and FIG. 13, an explanation will be given on an example of operation performed in loading and executing the application 111 via the upper file system 115 and the lower file system 114.

After executing the verification program 110, continuously, execution of the application 111 is started (step 701).

A loader starts a loading operation of an execution image of the application 111 from the storage 104, and the upper file system 115 starts readout (steps 702 and 703). At this time, it is determined whether or not a block subject to the readout exists in the disc cache area 108 (step 704). In specific, a procedure from steps 505 to 509 in FIG. 8 is carried out, and the cache management unit 119 determines whether or not code data of a block number calculated in step 509 exists in the disc cache area 108.

If the code data subject to the readout exists in the disc cache area 108 (YES in step 704), the cache management unit 119 reads out relevant cache data 125 from the disc cache area 108, and transfers the cache data 125 read out to the loader (step 705). In specific, the cache management unit 119 transfers the cache data 125 read out from the disc cache area 108 to the block access API unit 117, and after that, a procedure of steps 514 and 515 in FIG. 9 is carried out.

And also, the cache management unit 119 subtracts one from a reference count 124 of the cache data 125 read out (step 706).

If a value of the reference count 124 becomes zero as a result of subtracting one from the reference count 124 (YES in step 707), the cache management unit 119 releases a relevant area to allow use of the area as a new disc cache (step 708). In other words, if access to cache data is carried out number of times equivalent to number of times of access indicated in FIG. 3, the cache management unit 119 nullifies the cache data.

On the other hand, if there is no block subject to the readout in the disc cache area 108 in step 704 (NO in step 704), the upper file system 115 reads out relevant code data from the storage 104, and transfers the code data read out to the loader (step 709). In specific, a procedure of step 509 in FIG. 8 and steps 513 to 515 in FIG. 9 is carried out.

If the loading has been completed (YES in step 710), a process is completed.

On the other hand, if the loading of the execution image has not been completed (NO in step 710), the device access unit 116 calculates a block number to be accessed by the device access unit 116 next (step 711), and a procedure of and after step 704 is repeated.

***Description of Effects of Embodiment***

As described above, in the present embodiment, cache data of data that is frequently accessed in data access via a file system out of cache data acquired by data access not via the file system, such as a secure boot, is kept without being overwritten. Therefore, in carrying out the data access via the file system, it is possible to use the cache data to carry out the data access at high speed.

Accordingly, the present embodiment allows efficient cache management under a configuration in which the data access via the file system and the data access not via the file system occur.

A partition subject to a secure boot is dedicated to readout. However, the conventional technology uses a conventional cache discarding algorithm realized by a file system, and determines cache data that should be discarded, using information available when an application is executed. Therefore, determination on cache data discarding cannot be made efficiently by the conventional technology.

According to the present embodiment, it is possible to learn a block that is used frequently in an application partition and to recognize number of times of readout until cache data corresponding to the block is discarded, by keeping a record on execution of an application in advance. According to the present embodiment, it is also possible to discard relevant cache data when the number of times of readout reaches a prescribed number of times by recognizing the number of times of readout until the cache data is discarded. In this way, it becomes possible to use an area in which the cache data is discarded as a new disc cache, and thereby to efficiently use the disc cache.

### Embodiment 2

In Embodiment 1, the explanation is given on the configuration that allows high-speed data readout and efficient use of a disc cache when there is one application. In the present embodiment, an explanation will be given on a configuration that allows the high-speed data readout and the efficient use of a disc cache when there are a plurality of applications.

In the present embodiment, mainly differences from Embodiment 1 will be explained.

Note that matters not explained below are the same as those in Embodiment 1.

***Description of Configuration***

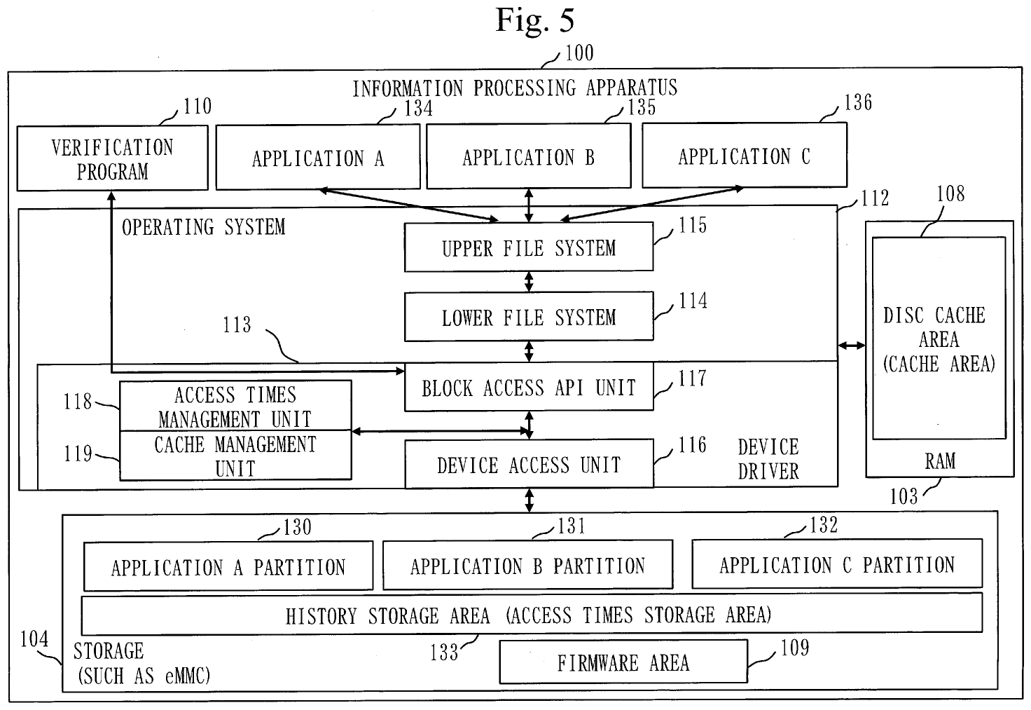

FIG. 5 illustrates an example of a functional configuration of an information processing apparatus 100 according to the present embodiment.

In comparison with FIG. 2, in FIG. 5, there exist three applications (an application A 134, an application B 135, and an application C 136). There also exist three application partitions (an application A partition 130, an application B partition 131, and an application C partition 132). The application A 134 is stored in the application A partition 130. The application B 135 is stored in the application B partition 131. The application C 136 is stored in the application C partition 132.

In FIG. 5, it is assumed that there are three applications. However, number of applications is arbitrary.

Also, in FIG. 5, there exists a history storage area 133 instead of the history storage area 106.

The history storage area 133 has a configuration corresponding to the three applications.

An explanation on other components is omitted since they are the same as those illustrated in FIG. 2.

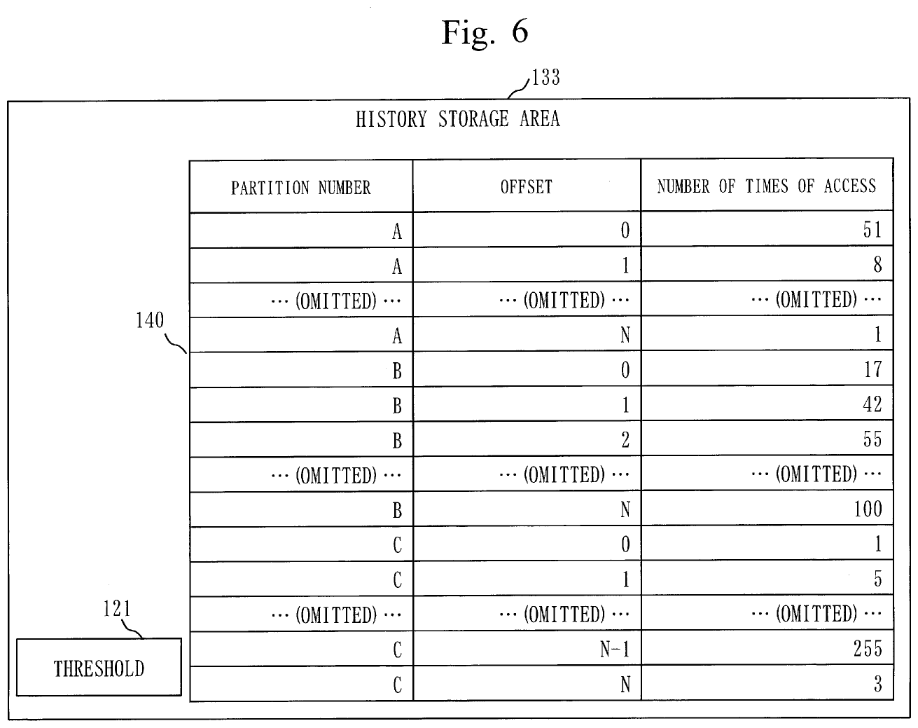

FIG. 6 illustrates an example of a configuration of the history storage area 133.

An entry 140 in FIG. 6 includes a partition number in addition to composition of the entry 120 in FIG. 3. In FIG. 6, the partition number is represented by A, B, and C as a matter of convenience. However, it is appropriate to indicate the partition number with a numerical value in an actual case.

A partition number A corresponds to the application A partition 130. A partition number B corresponds to the application B partition 131. A partition number C corresponds to the application C partition 132.

In the present embodiment, the access times management unit 118 stores number of times of access in a corresponding entry 140 for each of the application partitions.

***Description of Operation***

Next, an explanation will be given on operation of the information processing apparatus 100 according to the present embodiment.

In the present embodiment, an activation order of applications is not prescribed. Therefore, the access times management unit 118 calculates a threshold 121 for each of the applications. In other words, a process of FIG. 8 and FIG. 9 is carried out for each of the applications, and the access times management unit 118 stores in the history storage area 133, number of times of access of each code data for each of the applications and determines the threshold 121 based on the number of times of access for each of the applications.

Ways how to store the number of times of access in the history storage area 133 and how to determine the threshold 121 themselves are the same as those described in Embodiment 1. In the present embodiment, the number of times of access is recorded and the threshold 121 is determined for each of the three applications.

In addition, in the present embodiment, the cache management unit 119 extracts for each of the applications, code data for which number of times of access that is equal to or more than the threshold 121 is stored in the history storage area 106 when verification by the verification program 110 is carried out. Then, the cache management unit 119 sets as overwrite prohibition data and caches in the disc cache area 108, the extracted code data.

Operation of the cache management unit 119 itself is the same as that described in Embodiment 1. In the present embodiment, the cache management unit 119 compares the number of times of access with the thresholds 121 for each of the three applications, and determines whether or not to set the extracted code data as the overwrite prohibition data.

***Description of Effects of Embodiment***

According to the present embodiment, it is possible to obtain the same effects as those described in Embodiment 1 for a plurality of applications.

And also, according to the present embodiment, it is possible to carry out verification for each application partition. Therefore, it is possible to execute a verification program concurrently for the plurality of applications, and thus to accelerate a verification process.

### Embodiment 3

In Embodiment 1, a history storage area is in the storage 104. However, if size of an application partition is large, frequency of access to the storage 104 becomes high. Therefore, there is a possibility that performance deteriorates. In the present embodiment, in order to avoid this from happening, an explanation will be given on a configuration under which the history storage area is cached in the device driver 113. Under the configuration of the present embodiment, it is possible to control deterioration in speed of data access by writing information in the history storage area back in the storage 104 at a timing when writing in the history storage area is completed.

In the present embodiment, mainly differences from Embodiment 1 will be explained.

Note that mattes not explained below are the same as those in Embodiment 1.

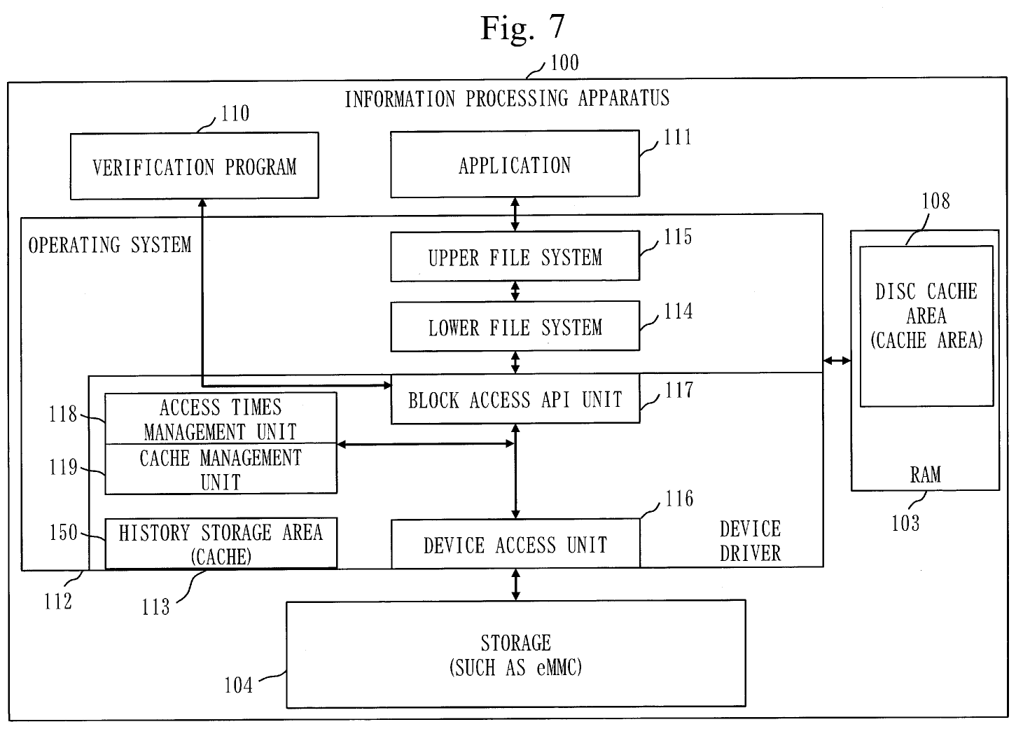

FIG. 7 illustrates an example of a functional configuration of an information processing apparatus 100 according to the present embodiment.

In comparison with FIG. 1, in FIG. 7, a history storage area (cache) 150 is added.

In FIG. 7, for easier understanding, the history storage area (cache) 150 is illustrated in the device driver 113. However, the history storage area (cache) 150 is physically arranged in the disc cache area 108 in the RAM 103.

Note that, for reasons of drawing, FIG. 7 does not illustrate an internal configuration of the storage 104, however, the internal configuration of the storage 104 in FIG. 7 is the same as that in FIG. 1. In other words, also in the storage 104 in FIG. 7, there exist the application partition 107, the history storage area 106, and the firmware area 109.

Next, an explanation will be given on an example of operation of the information processing apparatus 100 according to the present embodiment.

In the present embodiment, information in the history storage area 106 in the storage 104 is copied in the disc cache area 108 when the operating system 112 is activated. Thereby, the history storage area (cache) 150 is generated. The access times management unit 118 writes number of times of access in the history storage area (cache) 150. The access times management unit 118 also calculates a threshold 121 based on the number of times of access written in the history storage area (cache) 150.

Information in the history storage area (cache) 150 is written back in the history storage area 106 in the storage 104 after the threshold 121 is calculated by the access times management unit 118 and the application 111 is closed.

As described above, in the present embodiment, a cache area in the history storage area is realized in memory, and thus it is possible to avoid a storage from being frequently accessed and to control deterioration in performance.

Embodiments of the present invention are explained above. However, any two or more of these embodiments may be implemented in combination.

Alternatively, any one of these embodiments may be implemented partly.

Alternatively, any two or more of these embodiments may be implemented partly in combination.

Note that the present invention is not limited to these embodiments, and may be changed in various ways as necessary.

### REFERENCE SIGNS LIST

100: information processing apparatus; 101: processor; 102: bus; 103: RAM; 104: storage; 105: I/O device; 106: history storage area; 107: application partition; 108: disc cache area; 109: firmware area; 110: verification program; 111: application; 112: operating system; 113: device driver; 114: lower file system; 115: upper file system; 116: device access unit; 117: block access API unit; 118: access times management unit; 119: cache management unit; 130: application A partition; 131: application B partition; 132: application C partition; 133: history storage area; 134: application A; 135: application B; 136: application C; 150: history storage area (cache)

1. An information processing apparatus comprising:
a cache area;
an access times storage area to store number of times of access via a file system for each of a plurality of pieces of data; and
processing circuitry, when access to the plurality of pieces of data not via the file system occurs, to set as overwrite prohibition data and to cache in the cache area, data for which number of times of access that is equal to or more than a threshold is stored in the access times storage area, the threshold being determined based on number of times of access of the plurality of pieces of data.

2. The information processing apparatus according to claim 1,
wherein the processing circuitry caches data for which number of times of access that is less than the threshold is stored in the access times storage area, without overwriting on the overwrite prohibition data.

3. The information processing apparatus according to claim 1,
wherein the processing circuitry writes in the cache area, number of times of access that is stored in the access times storage area, associating the number of times of access with data to be cached in the cache area.

4. The information processing apparatus according to claim 3,
wherein if access via the file system to the data that is cached in the cache area is carried out number of times equivalent to the number of times of access, the processing circuitry nullifies the data cached in the cache area.

5. The information processing apparatus according to claim 1,
wherein when access to the plurality of pieces of data not via the file system occurs for verification of integrity and authenticity of the plurality of pieces of data, the processing circuitry sets as the overwrite prohibition data and caches in the cache area, the data for which number of times of access that is equal to or more than the threshold is stored in the access times storage area.

6. The information processing apparatus according to claim 5,
wherein the access times storage area stores number of times of access via the file system for each of a plurality of pieces of code data that constitute an application program, and
wherein when access to the plurality of pieces of code data not via the file system occurs for the verification of integrity and authenticity of the plurality of pieces of code data that constitute the application program, the processing circuitry sets as the overwrite prohibition data and caches in the cache area, code data for which number of times of access that is equal to or more than the threshold is stored in the access times storage area.

7. The information processing apparatus according to claim 6,
wherein the access times storage area stores, as to a plurality of application programs and for each of the application programs, the number of times of access via the file system for each of the plurality of pieces of code data that constitute the application program, and
wherein when the access not via the file system to the plurality of pieces of code data of the plurality of application programs occurs for the verification of integrity and authenticity, the processing circuitry sets as the overwrite prohibition data and caches in the cache area, the code data for which number of times of access that is equal to or more than the threshold is stored in the access times storage area, for each of the application programs.

8. The information processing apparatus according to claim 7,
wherein the processing circuitry uses a threshold determined for each of the application programs, and for each of the application programs, sets as the overwrite prohibition data and caches in the cache area, code data for which number of times of access that is equal to or more than a corresponding threshold is stored in the access times storage area.

9. The information processing apparatus according to claim 1,
wherein the information processing apparatus includes the access times storage area that is provided in cache memory for a device driver.

10. An information processing method by a computer having a cache area and an access times storage area that stores number of times of access via a file system for each of a plurality of pieces of data, the information processing method comprising:
setting as overwrite prohibition data and caching in the cache area, data for which number of times of access that is equal to or more than a threshold is stored in the access times storage area, the threshold being determined based on number of times of access of the plurality of pieces of data, when access to the plurality of pieces of data not via the file system occurs.

11. A non-transitory computer readable medium storing an information processing program that causes a computer having a cache area and an access times storage area that stores number of times of access via a file system for each of a plurality of pieces of data to execute:
a cache management process of setting as overwrite prohibition data and caching in the cache area, data for which number of times of access that is equal to or more than a threshold is stored in the access times storage area, the threshold being determined based on number of times of access of the plurality of pieces of data, when access to the plurality of pieces of data not via the file system occurs.

12. The information processing apparatus according to claim 2,
wherein the processing circuitry writes in the cache area, number of times of access that is stored in the access times storage area, associating the number of times of access with data to be cached in the cache area.

13. The information processing apparatus according to claim 12,
wherein if access via the file system to the data that is cached in the cache area is carried out number of times equivalent to the number of times of access, the processing circuitry nullifies the data cached in the cache area.
